(19) United States
(12) Patent Application Publication
(10) Pub. No.: US 2026/0295942 A1
(43) Pub. Date: Oct. 1, 2026

(54) Multi-Channel Hotend

(71) Applicant: Owen Bachyrycz, Kingston, MA (US)

(72) Inventor: Owen Bachyrycz, Kingston, MA (US)

(21) Appl. No.: 19/094,762

(22) Filed: Mar. 28, 2025

(51) Int. Cl. B29C 64/295; B29C 64/118; B29C 64/321; B33Y 30/00; B33Y 40/00

(52) U.S. Cl. CPC B29C 64/295; B29C 64/118; B29C 64/321; B33Y 40/00; B33Y 30/00

(57) ABSTRACT

A hotend for a FDM 3D-Printers that enables high-speed printing by splitting the filament path into three separate channels allowing the filament to melt more evenly and quickly than a traditional single channel hotend. This multi-channel geometry is achieved by installing a multi-channel EDM electrode into the hotend rather than machining the channels to reduce cost and complexity.

### CROSS-REFERENCE TO RELATED APPLICATIONS

This non-provisional patent application is relevant to provisional patent 63/572,886.

### BACKGROUND OF THE INVENTION

This invention relates to additive manufacturing (3D printing), and more specifically, to improving the filament melting capability of a 3D printer hotend.
Before this invention, hotends would consist of a single cylindrical channel for the filament to flow through.
Typical 3D printer hotends struggle when melting large volumes of filament because they only melt the filament from the outside, leading to the filament being too cool to extrude properly.
The multi-channel hotend splits the filament into three smaller channels, heating the filament more efficiently which allows it to extrude at higher speeds in the same size hotend.

### SUMMARY OF THE INVENTION

### 3D Printer Hotend With Multiple Filament Channels

An FDM (Fused Deposition Modeling) 3D-Printer using a motor (extruder) to push plastic filament through a heater (commonly called a hotend) and a nozzle to create a consistent flow of molten plastic. The hotend and nozzle are moved by the printer's motion system to extrude filament onto a heated print surface in precise locations to form a solid, 3-dimensional object.

A hotend for a FDM 3D-Printers that enables high-speed printing by splitting the filament path into three separate channels allowing the filament to melt more evenly and quickly than a traditional single channel hotend. This multi-channel geometry is achieved by installing a multi-channel EDM electrode into the hotend rather than machining the channels to reduce cost and complexity.

### BRIEF DESCRIPTION OF DRAWINGS

FIG. 1: Exploded view of hotend assembly with multi-channel insert

FIG. 2: Section view of multi-channel insert detailing the three channels for filament to flow through.

FIG. 3: Top view of assembled hotend with multi-channel insert.

### DETAILED DESCRIPTION OF THE INVENTION

An FDM (Fused Deposition Modeling) 3D-Printer using a motor (extruder) to push plastic filament through a heater (commonly called a hotend) and a nozzle to create a consistent flow of molten plastic. The hotend and nozzle are moved by the 3D-Printer's motion system to extrude filament onto a heated print surface in precise locations to form a solid, 3-dimensional object.

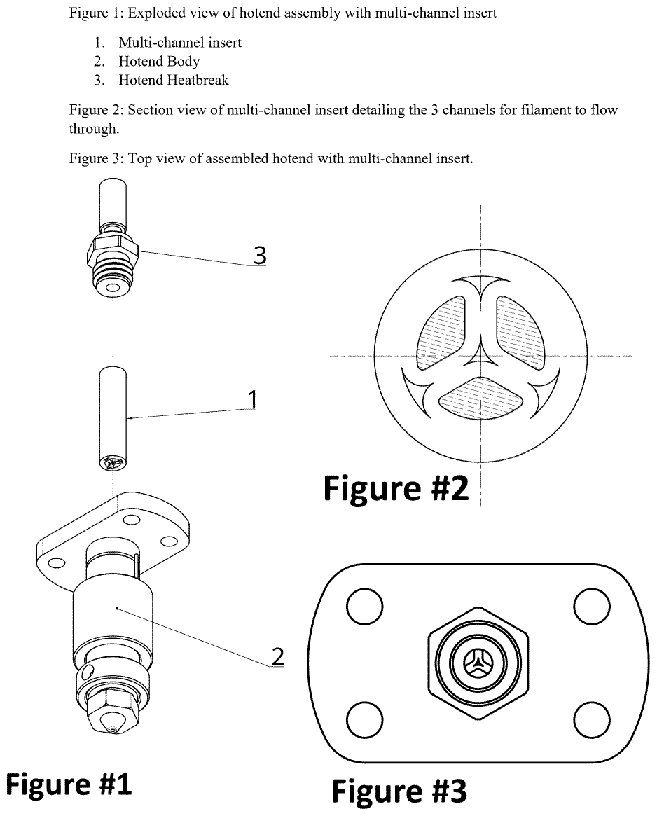

This hotend for a FDM 3D-Printers enables high-speed printing by splitting the filament path into three separate channels (FIG. 2) allowing the filament to melt more evenly and quickly than a traditional single channel hotend. This multi-channel geometry is achieved by installing a multi-channel EDM electrode into the hotend (FIG. 1) rather than machining the channels to reduce cost and complexity.

This hotend for a FDM 3D-Printer has three channels for the molten filament to flow through, as opposed to a single bore found in other hotends. When printing at high filament flow rates with traditional hotend, the filament is moving through the hot end quickly and because the plastic filament has poor thermal conductivity, the center of filament will be cooler than filament closer to the walls of the hotend. This results in undesirable behavior such as die swell when the filament exits the nozzle which can cause issues with the 3D-Printing process. This also limits how much filament can be extruded out of the hotend per second (referred to as flow, measured in mm^/s), limiting the speed at which the printer can operate.

The multi-channel hotend described in this patent solves this issue by splitting the filament path into three smaller channels. Since the channels are a smaller diameter, the heat can transfer more quickly to the center of the channel and the center of the filament will be thoroughly molten even at high flow rates. This multi-channel geometry is achieved by inserting a copper multi-channel electrode commonly used in electrical discharge machining into the hotend. (FIG. 1) Manufacturing the hotend this way provides the aforementioned performance benefits while being as simple to manufacture as a traditional single channel hotend. The electrodes are available in a variety of materials and sizes to suit different applications and are inexpensive, allowing the hotends to be manufactured at a much lower cost than if the channels were traditionally machined.

What is claimed is:

1. The multi-channel hotend significantly increases the filament melting capacity of a 3D printer hotend without significantly increasing the cost to manufacture the hotend.
